(19) United States
(12) Patent Application Publication
(10) Pub. No.: US 2025/0198437 A1
(43) Pub. Date: Jun. 19, 2025

(54) Air Bag Retainer with Assembly Prevention and Verification

(71) Applicant: Illinois Tool Works Inc., Glenview, IL (US)

(72) Inventor: Mark A. Beyer, Armada, MI (US)

(21) Appl. No.: 18/965,611

(22) Filed: Dec. 2, 2024

Related U.S. Application Data
(60) Provisional application No. 63/610,467, filed on Dec. 15, 2023.

(51) Int. Cl. F16B 5/02; B60R 21/20

(52) U.S. Cl. CPC F16B 5/02; B60R 21/20

(57) ABSTRACT

A fastener assembly for coupling a first component to a second component is described. The assembly includes a fastener and a stamped-metal retainer. The fastener includes a head and a shank, while the stamped-metal retainer features a body portion and a pair of retainer legs resiliently connected to the body portion, transitioning between a first and second position. The body portion incorporates an internally threaded collar that defines a retainer opening that can receive and secure at least part of the shank. Each retainer leg includes a planar portion with a first tab and a second tab positioned on opposite sides of the planar portion. In the first position, the first tab prevents the fastener from being driven into the internally threaded collar; in the second position, it permits the fastener to be driven into the collar.

### RELATED APPLICATION

The present application claims priority to U.S. Provisional Patent Application No. 63/610,467, filed Dec. 15, 2023, and entitled “Air Bag Retainer with Assembly Prevention and Verification,” which is hereby incorporated by reference in its entirety.

### BACKGROUND

Automotive components require fastening techniques that are simple to manufacture and assemble. Further, fastening techniques should above all be reliable and efficient. In some instances, objects need to be secured to the vehicle to mitigate movement and/or shifting during operation, which can result in damage or kinking to the object. For example, airbags, tubes, hoses, wires, and other objects are often secured to the vehicle components via fasteners. When a fastener is installed incorrectly such that the fastener is not fully inserted into the opening, the fastener can detach and/or the object being fastened can become damaged or loose. Similarly, when an object is attached incorrectly to a fastener, the object can detach from the fastener or become damaged or loose.

In manufacturing and assembly processes, particularly in automotive and structural component assembly, it is essential to ensure that each fastener is correctly positioned and securely fastened. Incorrect installation can lead to misalignment, structural weaknesses, and potential failures. To address these issues, visual inspection or automated systems are often used, but these methods may not ensure complete accuracy. Therefore, there is a need for a fastening system that includes a built-in verification mechanism to confirm secure and correct installation.

### SUMMARY

The present disclosure relates generally to a fastening system to form a connection between components, substantially as illustrated by and described in connection with at least one of the figures, as set forth more completely in the claims.

### DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1a illustrates a perspective assembly view of the fastening system with a fastener assembly in accordance with aspects of this disclosure.

FIG. 1b illustrates a perspective view of the fastening system in an assembled position.

FIGS. 1c and 1d illustrate first and second perspective assembly views of the fastener assembly.

FIGS. 1e through 1h illustrate first, second, third, and fourth side assembly views of the fastener assembly.

FIG. 2a illustrates an isometric cross-sectional view of the fastener assembly taken along cut line A-A (FIG. 1b).

FIG. 2b illustrates a side elevation cross-sectional view of the fastener assembly taken along cut line A-A (FIG. 1b).

FIG. 2c illustrates a top plan cross-sectional view of the fastener assembly taken along cut line B-B (FIG. 1e).

FIGS. 3a through 3d illustrate, respectively, side elevational view of the fastener assembly during different stages of assembly.

### DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein is not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent to or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y, and/or z” means “one or more of x, y, and z.”

Disclosed is a fastener assembly comprising a retainer and a bolt, pre-assembled as a part-in-assembly (PIA) for streamlined delivery to the customer. Unlike traditional fastener assemblies, this design significantly reduces packaging space requirements. Additionally, the disclosed fastener assembly offers easier installation, enables assembly verification through torque/angle monitoring, and eliminates the need for a weld nut in the component (e.g., vehicle body), enhancing efficiency and reliability. While the disclosed fastener can be used in a variety of applications, one such application includes airbag installation in a vehicle.

In one example, a fastener assembly for coupling a first component to a second component comprises: a fastener having a head and a shank; and a stamped-metal retainer having a body portion and a pair of retainer legs resiliently coupled to the body portion and configured to transition between a first position and a second position during installation in the second component, wherein the body portion includes an internally-threaded collar that defines a retainer opening configured to receive and secure at least a portion of the shank, wherein each of the pair of retainer legs comprises a planar portion having a first tab and a second tab positioned on opposite sides of the planar portion, and wherein the first tab is configured to prevent the fastener from being driven into the internally-threaded collar when in the first position and to permit the fastener to be driven into the internally-threaded collar when in the second position.

In some examples, each of the first tab and the second tab has a generally L-shaped geometry.

In another example, a fastener assembly for coupling a first component to a second component comprises: a fastener having a head and a shank; and a retainer having a body portion and a pair of retainer legs resiliently coupled to the body portion and configured to transition between a first position and a second position, wherein the body portion includes an internally-threaded collar that defines a retainer opening configured to receive and secure at least a portion of the shank, and wherein each of the pair of retainer legs comprises a first tab configured to prevent the fastener from being driven into the internally-threaded collar when in the first position and to permit the fastener to be driven into the internally-threaded collar when in the second position.

In some examples, each of the pair of retainer legs comprises an outer planar portion and an inner planar portion connected by a bend section.

In some examples, the first tab is coupled to the outer planar portion.

In some examples, the first tab is coupled to the outer planar portion at a transverse angle.

In some examples, each of the pair of retainer legs comprises a second tab coupled to the outer planar portion opposite the first tab.

In some examples, the second tab is coupled to the outer planar portion at a transverse angle.

In some examples, the first tab has a generally L-shaped geometry.

In some examples, the second tab has a generally L-shaped geometry.

In some examples, the first tab of one of the pair of retainer legs is configured to interlock with the second tab of the other retainer leg.

In some examples, the first and second tabs are positioned at different vertical positions along the outer planar portion.

In some examples, a distance between the first tab and the body portion is less than a distance between the second tab and the body portion.

In some examples, the retainer is a stamped-metal retainer.

In some examples, the fastener is a metal bolt.

In yet another example, a stamped-metal retainer configured to couple with a fastener having a head and a shank comprises: a body portion including an internally-threaded collar that defines a retainer opening configured to receive and secure at least a portion of the shank; and a pair of retainer legs resiliently coupled to the body portion and configured to transition between a first position and a second position, wherein each of the pair of retainer legs comprises a first tab configured to prevent the fastener from being driven into the internally-threaded collar when in the first position and to permit the fastener to be driven into the collar when in the second position.

In some examples, each of the pair of retainer legs comprises an outer planar portion and an inner planar portion connected by a bend section.

In some examples, the first tab is coupled to the outer planar portion at a transverse angle, and a second tab is coupled to the outer planar portion at a transverse angle, with the first and second tabs positioned on opposite sides of the outer planar portion.

In some examples, each of the first and second tabs has a generally L-shaped geometry.

In some examples, the first tab of one retainer leg is configured to interlock with the second tab of the other retainer leg.

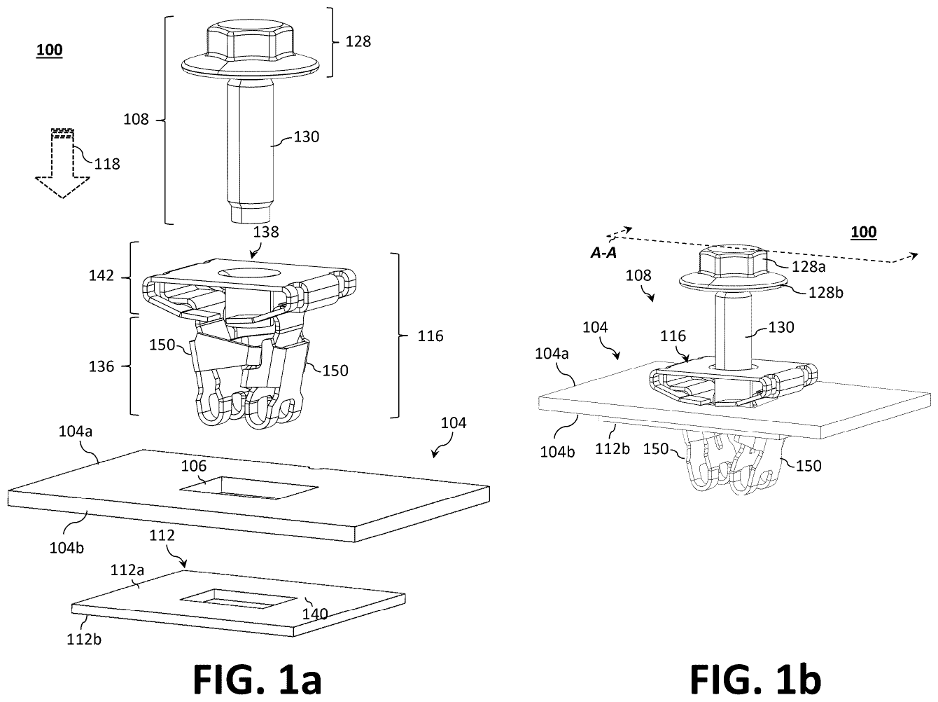

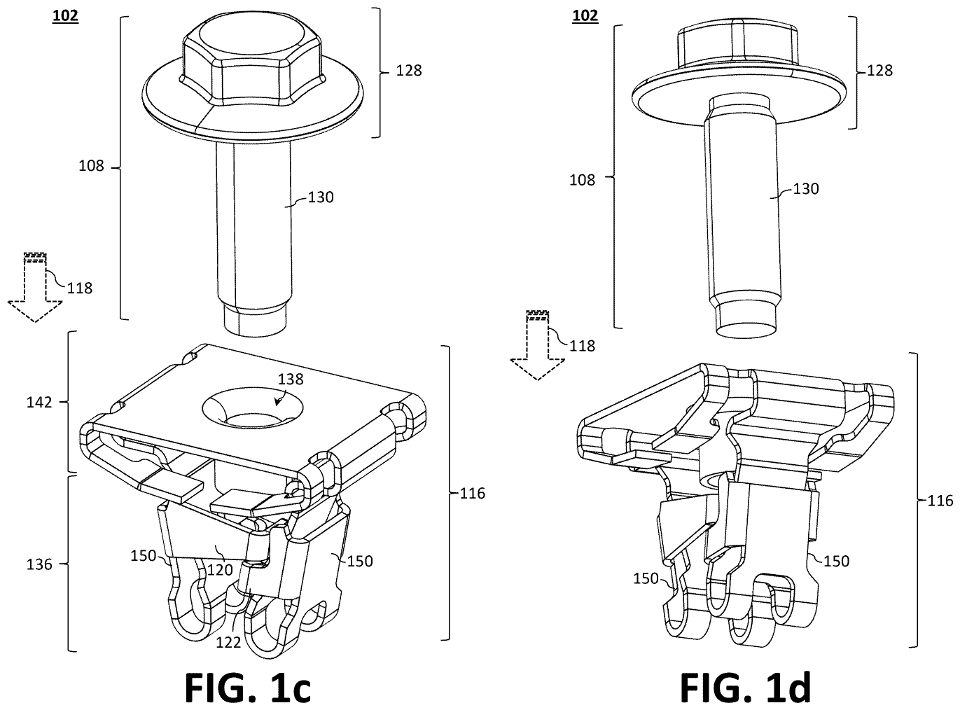

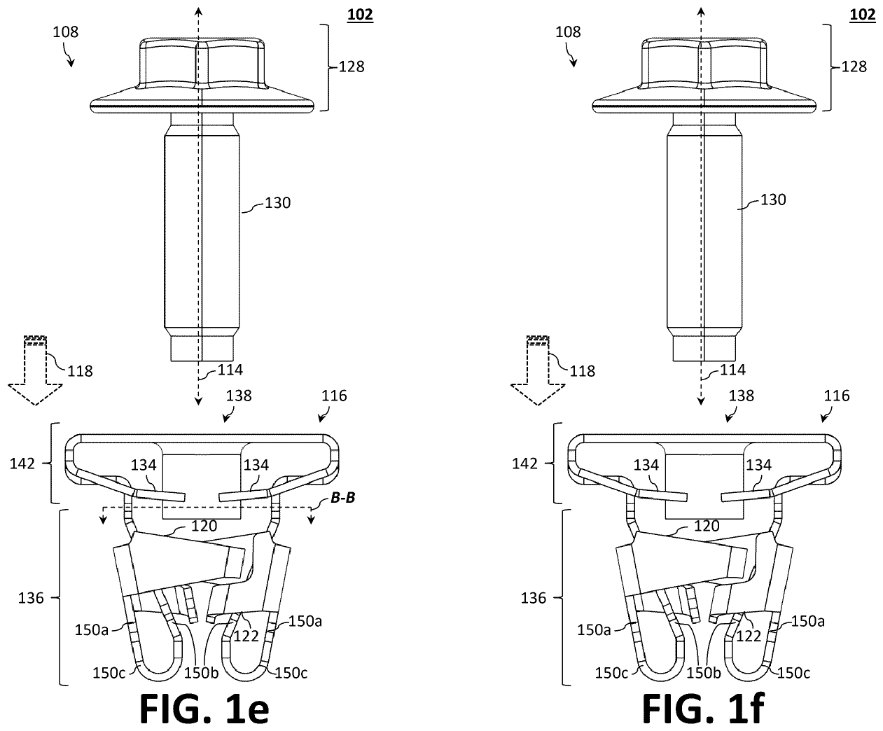

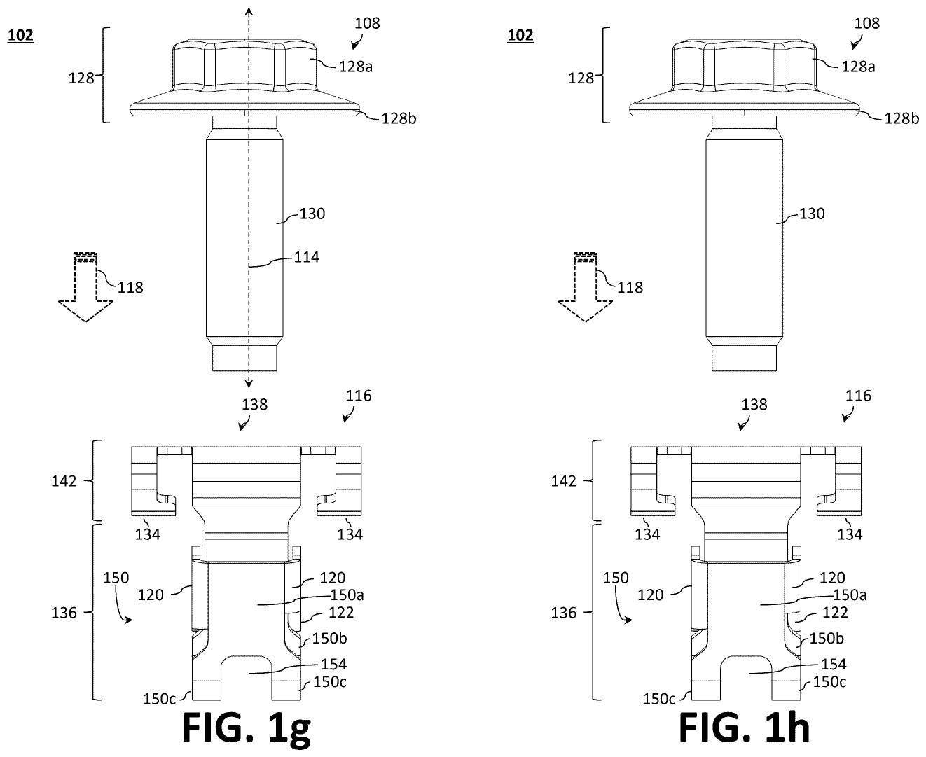

FIG. 1a illustrates a perspective assembly view of the fastening system 100 with a fastener assembly 102 in accordance with aspects of this disclosure, while FIG. 1b illustrates a perspective view of the fastening system 100 in an assembled position. The illustrated fastening system 100 generally comprises a fastener assembly 102 for installation in a first component 104 and a second component 112. As illustrated, the fastener assembly 102 is composed of multiple components, including a fastener 108 and a retainer 116, configured to fit together in one or more positions, including a first position (e.g., a shipped position, such as a partially assembled position) and a second position (e.g., an installed position). FIGS. 1c and 1d illustrate first and second perspective assembly views of the fastener assembly 102, while FIGS. 1e through 1h illustrate first, second, third, and fourth side assembly views of the fastener assembly 102.

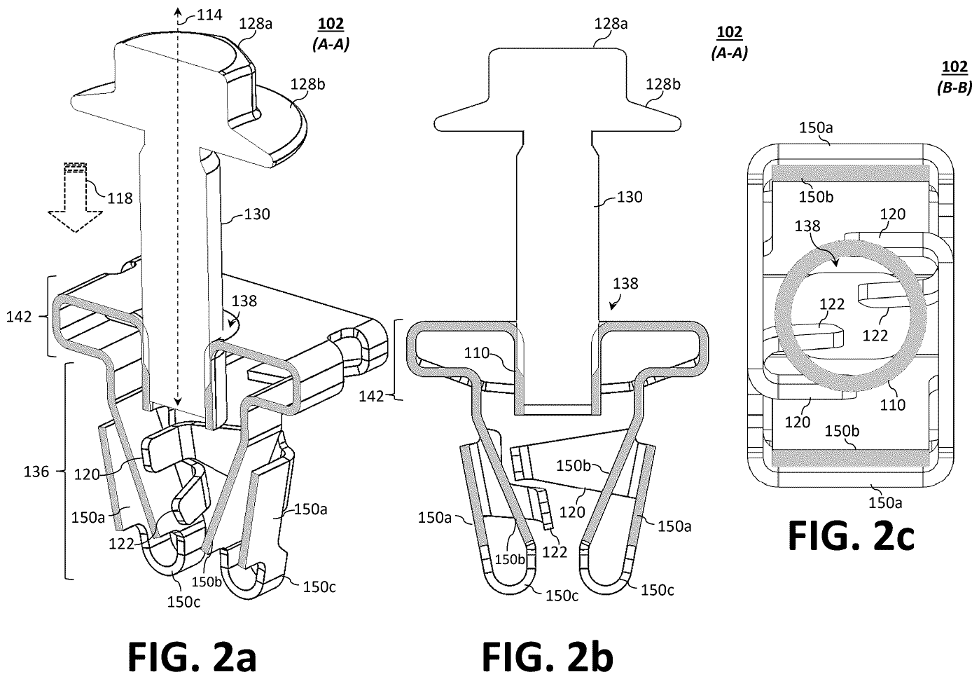

FIGS. 2a and 2b illustrate, respectively, isometric and side elevation cross-sectional views of the fastener assembly 102 taken along cut line A-A (FIG. 1b), while FIG. 2c illustrates a top plan cross-sectional view of the fastener assembly 102 taken along cut line B-B (FIG. 1e). As can be appreciated, the fastener 108 and the retainer 116 of the fastener assembly 102 are configured to engage and securely retain one another, facilitating a reliable connection between the first component 104, the second component 112, and to another component (e.g., an airbag) via the fastener 108. This engagement ensures that the first component 104 and the second component 112 remain properly aligned and connected throughout assembly and installation.

In the illustrated example, the first component 104 defines an A-side surface 104a (e.g., a first surface, such as an exterior surface) and a B-side surface 104b (e.g., a second surface, such as an interior surface). The second component 112 similarly defines an A-side surface 112a (e.g., a first surface, such as an exterior surface) and a B-side surface 112b (e.g., a second surface, such as an interior surface). The first component 104 and/or the second component 112 may be, for example, an automotive panel or a structural component of a vehicle, such as doors, pillars (e.g., an A-pillar, B-pillar, C-pillar, etc.), airbag components, dashboard components (e.g., a cross member, bracket, frame, etc.), seat frames, center consoles, fenders, sheet metal framework, or the like. Depending on the application, the first component 104 and/or the second component 112 may be fabricated from metal (or a metal alloy), synthetic or semi-synthetic polymers (e.g., plastics such as acrylonitrile butadiene styrene (ABS) and polyvinyl chloride (PVC)), composite materials (e.g., fiberglass), or a combination thereof.

Each of the first component 104 and the second component 112 includes, defines, or otherwise provides one or more openings (e.g., holes, windows, or cutouts) formed during the manufacturing of the first component 104 and the second component 112, as applicable. As best illustrated in FIG. 1a, the first component 104 defines a first opening 106 and the second component 112 defines a second opening 140 that are each configured to, once aligned, receive and retain the fastener assembly 102 relative to the first component 104 and the second component 112. In the illustrated example, the first component 104 provides the first opening 106 as a rectangular window sized to receive a portion of the fastener assembly 102, while the second component 112 provides the second opening 140 as a rectangular window sized to receive a portion of the fastener assembly 102.

As illustrated, the fastener 128 comprises a head 128a and a shank 130. The shank 130 extends generally perpendicularly from the underside of the head 128a. In the illustrated example, the head 128a is hexagonal and the shank 130 is threaded. While the fastener 128 is illustrated as a threaded bolt having a head 128a that is hexagonal, other types of fasteners are contemplated. For example, the fastener 128 is illustrated as a flanged bolt having a flange 128b between the head 128a and the threaded shank 130.

The retainer 116 includes a body portion 142 and a fastener portion 136 having retainer legs 132. The body portion 142 defines a retainer opening 138, through which the shank 130 of the fastener 128 passes during assembly. In the illustrated example, the retainer 116 comprises an internally-threaded collar 110, which defines the retainer opening 138. The illustrated internally-threaded collar 110 is oriented downwardly such that it extends between the retainer legs 132 of the fastener portion 136. The fastener 128 threadedly engages the internally-threaded collar 110 through a rotational movement about a central longitudinal axis 114. The body portion 142 can include one or more spring tabs 134 configured to contact the first component 104 when installed, thereby mitigating unwanted movements and/or buzz, squeak, and rattle (BSR).

The illustrated fastener portion 136 includes two retainer legs 132 that are resiliently attached to and beneath the body portion 142. The retainer legs 132 are configured to flex relative to the central longitudinal axis 114 as the fastener portion 136 is inserted through aligned openings 106, 140 in the first and second components 104, 112. In the illustrated example, each retainer leg 132 comprises of an outer portion 132a and an inner portion 132b connected by a bend section 132c (e.g., a u-shaped bend section). Each of the outer portion 132a and the inner portion 132b are illustrated as generally planar (e.g., flat), parallel, and spaced to form a gap therebetween.

Each retainer leg 132 includes one or more tabs attached to its outer portion 132a. In the illustrated example, each retainer leg 132 comprises a pair of tabs: a first tab 120 and a second tab 110. These tabs are positioned on opposite sides of the outer portion 132a. As best shown in FIG. 2c, both the first tab 120 and the second tab 110 have a generally L-shaped geometry, comprising two planar sections connected at a transverse angle, depicted as a 90-degree angle. The first tab 120 and the second tab 110 are, in turn, attached to the outer portion 132a at a transverse angle (e.g., 90 degrees). Additionally, the first tab 120 and second tab 110 are positioned at different vertical positions along the outer portion 132a, enabling the first tab 120 on one retainer leg 132 to complement or interlock with the second tab 122 on the opposite retainer leg 132, as illustrated in FIGS. 2a and 2b. That is, the distance between the first tab 120 and the body portion 142 is less than a distance between the second tab 110 and the body portion 142.

The components of the fastener assembly 102 may be formed as a unitary structure. The retainer 116 may be fabricated as a single component using a metal stamping process. For example, the retainer 116 can be stamped from a sheet of metal using a die stamping process to define the geometry of the various features and then bent to assume the shape of the retainer 116 via one or more bending steps. The internally-threaded collar 110 can be extruded and/or cold-formed.

The fastener 108 can be fabricated from metal by forming a metal blank through processes such as hot forging or precision machining to achieve the desired size and shape for the shank 130 and head 128a. The shank 130 is then threaded using dies or threading tools, and in some cases, the fastener 108 undergoes heat treatment to enhance its mechanical properties, followed by surface treatments (e.g., galvanizing or plating to improve corrosion resistance and durability).

In another example, the fastener 108 can be fabricated from plastic via mold tooling and a plastic-injection molding process. In yet another example, the fastener 108 can be a printed thermoplastic material component that can be printed with great accuracy and with numerous details, which is particularly advantageous for creating components requiring complex and/or precise features. Additive manufacturing techniques obviate the need for mold tooling typically associated with plastic injection molding, thereby lowering up-front manufacturing costs, which is particularly advantageous in low-volume productions. In some examples, the fastener assembly 102 may be fabricated using material extrusion (e.g., fused deposition modeling (FDM), stereolithography (SLA), selective laser sintering (SLS), material jetting, binder jetting, powder bed fusion, directed energy deposition, VAT photopolymerization, and/or any other suitable type of additive manufacturing/3D printing process).

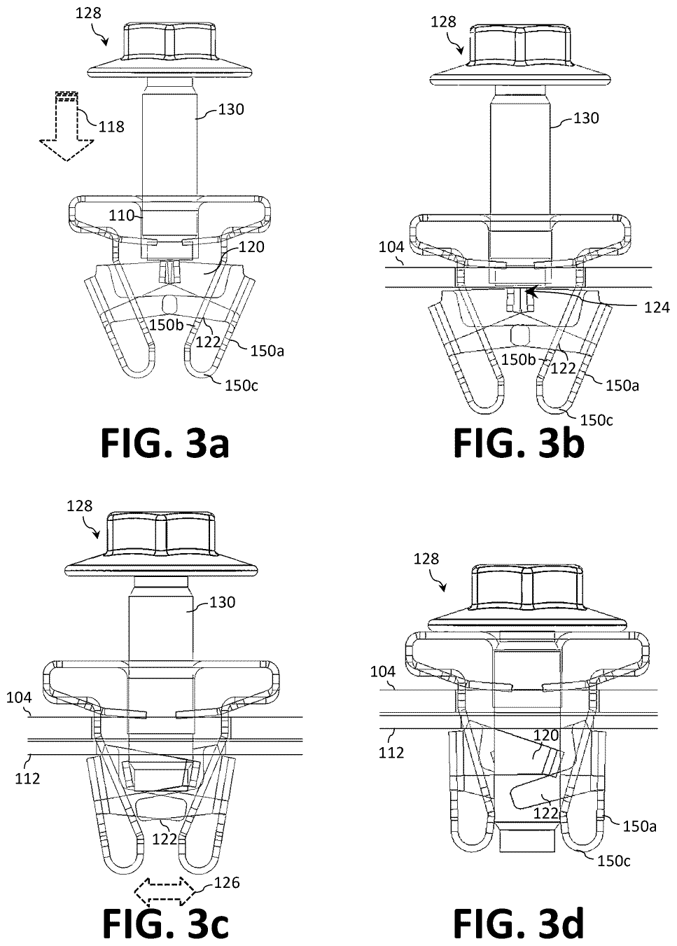

FIGS. 3a through 3d illustrate, respectively, side elevational view of the fastener assembly 102 during four stages of assembly. During installation, with reference to FIGS. 3a through 3d, as the fastener assembly 102 is inserted into the aligned first opening 106 in the first component 104 and the second opening 140 in the second component 112 as indicated by arrow 118, the inner walls of the retainer compress the retainer legs 132 toward the longitudinal axis 114.

When manufactured as a stamped-metal component, for example, the first tab 120 and second tab 110 are bent or otherwise oriented inwardly (toward the longitudinal axis 114) to partially obstruct the fasteners pathway at the lower section of the retainer opening 138. This configuration ensures that the tabs 120, 122 prevent the fastener 108 from being driven into the retainer 116 unless the retainer 116 is properly installed into the second component 112. As shown in FIG. 3a, the fastener assembly 102 is initially in its first position. When the retainer 116 is installed into the first component 104 (e.g., a primary panel, such as an airbag flange) at the tier customer, the tabs 120, 122 remain in a blocking position, preventing the fastener 108 from being driven, as depicted in FIG. 3b at location 124.

Upon installation of the retainer 116 into the second component 112 (e.g., a secondary panel, such as vehicle body sheet metal), the retainer legs 132 are biased outwardly upon contact with the second component 112, as indicated by arrow 126, repositioning the first tab 120 and the second tab 122. This movement clears the obstruction, allowing the fastener 108 to be driven into place, as shown in FIG. 3c. If an operator attempts to drive the fastener 108 before the retainer 116 is properly installed in the second component 112, the fastener driver will prematurely “torque out,” indicating a failed installation. However, once the retainer 116 is correctly seated in the second component 112, the fastener 108 can be fully driven to assume its second position, as illustrated in FIG. 3d.

While the present method and/or system has been described with reference to certain implementations, it will be understood by those skilled in the art that various changes may be made, and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

1. A fastener assembly for coupling a first component to a second component, the fastener assembly comprising:
a fastener having a head and a shank; and
a stamped-metal retainer having a body portion and a pair of retainer legs resiliently coupled to the body portion and configured to transition between a first position and a second position during installation in the second component,
wherein the body portion includes an internally-threaded collar that defines a retainer opening configured to receive and secure at least a portion of the shank,
wherein each of the pair of retainer legs comprises a planar portion having a first tab and a second tab positioned on opposite sides of the planar portion, and
wherein the first tab is configured to prevent the fastener from being driven into the internally-threaded collar when in the first position and to permit the fastener to be driven into the internally-threaded collar when in the second position.

2. The fastener assembly of claim 1, wherein each of the first tab and the second tab has a generally L-shaped geometry.

3. A fastener assembly for coupling a first component to a second component, the fastener assembly comprising:
a fastener having a head and a shank; and
a retainer having a body portion and a pair of retainer legs resiliently coupled to the body portion and configured to transition between a first position and a second position,
wherein the body portion includes an internally-threaded collar that defines a retainer opening configured to receive and secure at least a portion of the shank, and
wherein each of the pair of retainer legs comprises a first tab configured to prevent the fastener from being driven into the internally-threaded collar when in the first position and to permit the fastener to be driven into the internally-threaded collar when in the second position.

4. The fastener assembly of claim 3, wherein each of the pair of retainer legs comprises an outer planar portion and an inner planar portion connected by a bend section.

5. The fastener assembly of claim 4, wherein the first tab is coupled to the outer planar portion.

6. The fastener assembly of claim 4, wherein the first tab is coupled to the outer planar portion at a transverse angle.

7. The fastener assembly of claim 5, wherein each of the pair of retainer legs comprises a second tab coupled to the outer planar portion opposite the first tab.

8. The fastener assembly of claim 7, wherein the second tab is coupled to the outer planar portion at a transverse angle.

9. The fastener assembly of claim 4, wherein the first tab has a generally L-shaped geometry.

10. The fastener assembly of claim 7, wherein the second tab has a generally L-shaped geometry.

11. The fastener assembly of claim 7, wherein the first tab of one of the pair of retainer legs is configured to interlock with the second tab of the other retainer leg.

12. The fastener assembly of claim 7, wherein the first and second tabs are positioned at different vertical positions along the outer planar portion.

13. The fastener assembly of claim 7, wherein a distance between the first tab and the body portion is less than a distance between the second tab and the body portion.

14. The fastener assembly of claim 3, wherein the retainer is a stamped-metal retainer.

15. The fastener assembly of claim 3, wherein the fastener is a metal bolt.

16. A stamped-metal retainer configured to couple with a fastener having a head and a shank, the stamped-metal retainer comprising:
a body portion including an internally-threaded collar that defines a retainer opening configured to receive and secure at least a portion of the shank; and
a pair of retainer legs resiliently coupled to the body portion and configured to transition between a first position and a second position,
wherein each of the pair of retainer legs comprises a first tab configured to prevent the fastener from being driven into the internally-threaded collar when in the first position and to permit the fastener to be driven into the collar when in the second position.

17. The stamped-metal retainer of claim 16, wherein each of the pair of retainer legs comprises an outer planar portion and an inner planar portion connected by a bend section.

18. The stamped-metal retainer of claim 17, wherein the first tab is coupled to the outer planar portion at a transverse angle, and a second tab is coupled to the outer planar portion at a transverse angle, with the first and second tabs positioned on opposite sides of the outer planar portion.

19. The stamped-metal retainer of claim 18, wherein each of the first and second tabs has a generally L-shaped geometry.

20. The stamped-metal retainer of claim 18, wherein the first tab of one retainer leg is configured to interlock with the second tab of the other retainer leg.
